(19) United States
(12) Patent Application Publication
(10) Pub. No.: US 2020/0106713 A1
(43) Pub. Date: Apr. 2, 2020

(54) TWO CHANNEL TCP TO COMBAT SLOW START ON HIGH LATENCY CONNECTIONS

(71) Applicant: INTERNATIONAL BUSINESS MACHINES CORPORATION, Armonk, NY (US)

(72) Inventors: Douglas Griffith, Burnet, TX (US); Anand Teerth Desai, Austin, TX (US); Lloyd Phillips, Austin, TX (US); Steve Talmage, Austin, TX (US)

(21) Appl. No.: 16/146,186

(22) Filed: Sep. 28, 2018

(51) Int. Cl. H04L 12/911; H04L 12/931; H04L 29/06; H04L 12/841; H04L 12/26; H04L 12/891

(52) U.S. Cl. CPC H04L 47/726; H04L 49/205; H04L 69/14; H04L 47/822; H04L 69/16; H04L 43/12; H04L 47/41; H04L 47/283

(57) ABSTRACT

Methods, systems, and computer program products for two channel TCP are provided. Aspects include establishing a first TCP connection over a primary channel with a server, the primary channel having a first latency and a first bandwidth, establishing a second TCP connection over a secondary channel with the server, the secondary channel having a second latency and second bandwidth, establishing a first data stream with the server over the secondary channel at a first time period, and establishing a second data stream with the server over the primary channel during a second time period, wherein a start of the second time period is after the first time period.

### BACKGROUND

The present invention generally relates to transmission control protocols (TCP), and more specifically, to a two channel TCP to combat slow start on high latency connections.

As computer network technology advances, users of computing devices will continue to access content and data from memory locations that are not stored locally on a user device. With the advancement of streaming services for accessing media, users will continue to demand faster connections and larger bandwidth to access this media stored remotely from a user device. Unfortunately, some high bandwidth connections have a high latency. Initial connection protocols that utilize slow start up algorithms can cause a delay in access to content stored on servers due to the back and forth to establish the connection with high latency channels.

### SUMMARY

Embodiments of the present invention are directed to a computer-implemented method for decreasing TCP connection time for high latency channels. A non-limiting example of the computer-implemented method includes establishing a first TCP connection over a primary channel with a server, the primary channel having a first latency and a first bandwidth, establishing a second TCP connection over a secondary channel with the server, the secondary channel having a second latency and second bandwidth, establishing a first data stream with the server over the secondary channel at a first time period, and establishing a second data stream with the server over the primary channel during a second time period, wherein a start of the second time period is in parallel with the first time period.

Embodiments of the present invention are directed to a system for decreasing TCP connection time for high latency channels. A non-limiting example of the system includes a processor communicatively coupled to a memory, the processor configured to perform establishing a first TCP connection over a primary channel with a server, the primary channel having a first latency and a first bandwidth, establishing a second TCP connection over a secondary channel with the server, the secondary channel having a second latency and second bandwidth, establishing a first data stream with the server over the secondary channel at a first time period, and establishing a second data stream with the server over the primary channel during a second time period, wherein a start of the second time period is in parallel with the first time period.

Embodiments of the present invention are directed to a computer program product for decreasing TCP connection time for high latency channels, the computer program product comprising a computer readable storage medium having program instructions embodied therewith. The program instructions are executable by a processor to cause the processor to perform a method. A non-limiting example of the method includes A non-limiting example of the computer-implemented method includes establishing a first TCP connection over a primary channel with a server, the primary channel having a first latency and a first bandwidth, establishing a second TCP connection over a secondary channel with the server, the secondary channel having a second latency and second bandwidth, establishing a first data stream with the server over the secondary channel at a first time period, and establishing a second data stream with the server over the primary channel during a second time period, wherein a start of the second time period is in parallel with the first time period.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a cloud computing environment according to one or more embodiments of the present invention;

FIG. 2 depicts abstraction model layers according to one or more embodiments of the present invention;

FIG. 3 depicts a block diagram of a computer system for use in implementing one or more embodiments of the present invention;

FIG. 4 depicts a block diagram of a system for decreasing TCP connection time for high latency channels according to one or more embodiments of the invention; and

FIG. 5 depicts a flow diagram of a method for decreasing TCP connection time for high latency channels according to one or more embodiments of the invention.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

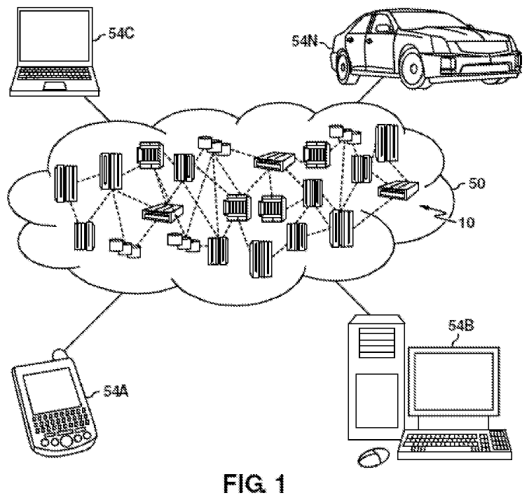

Referring now to FIG. 1, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

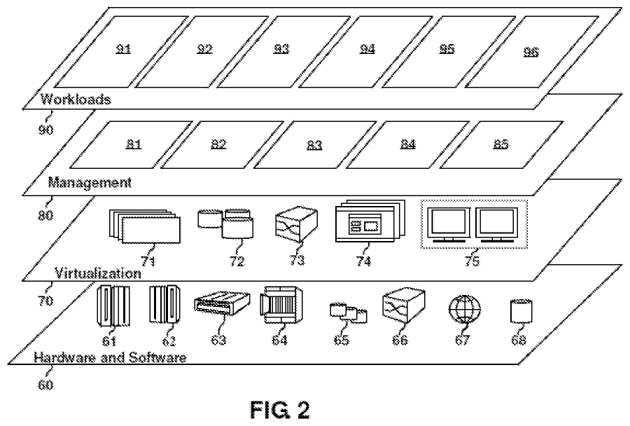

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and two channel transmission control protocol 96.

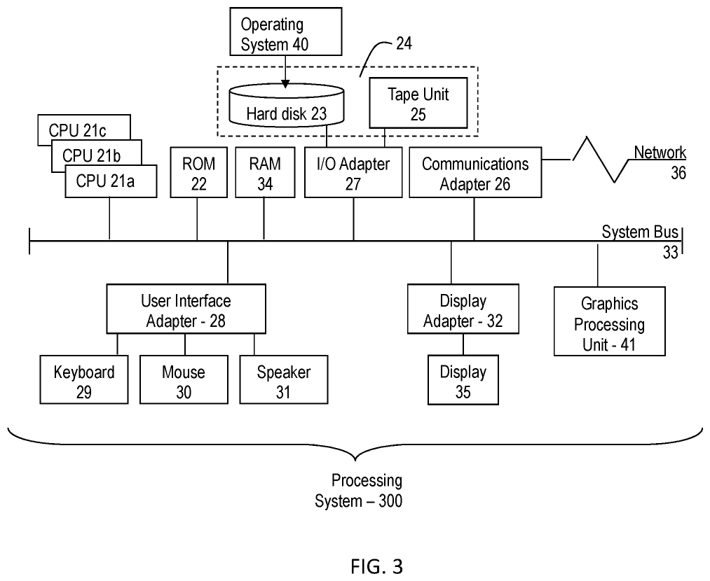

Referring to FIG. 3, there is shown an embodiment of a processing system 300 for implementing the teachings herein. In this embodiment, the system 300 has one or more central processing units (processors) 21a, 21b, 21c, etc. (collectively or generically referred to as processor(s) 21). In one or more embodiments, each processor 21 may include a reduced instruction set computer (RISC) microprocessor. Processors 21 are coupled to system memory 34 and various other components via a system bus 33. Read only memory (ROM) 22 is coupled to the system bus 33 and may include a basic input/output system (BIOS), which controls certain basic functions of system 300.

FIG. 3 further depicts an input/output (I/O) adapter 27 and a network adapter 26 coupled to the system bus 33. I/O adapter 27 may be a small computer system interface (SCSI) adapter that communicates with a hard disk 23 and/or tape storage drive 25 or any other similar component. I/O adapter 27, hard disk 23, and tape storage device 25 are collectively referred to herein as mass storage 24. Operating system 40 for execution on the processing system 300 may be stored in mass storage 24. A network adapter 26 interconnects bus 33 with an outside network 36 enabling data processing system 300 to communicate with other such systems. A screen (e.g., a display monitor) 35 is connected to system bus 33 by display adaptor 32, which may include a graphics adapter to improve the performance of graphics intensive applications and a video controller. In one embodiment, adapters 27, 26, and 32 may be connected to one or more I/O busses that are connected to system bus 33 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 33 via user interface adapter 28 and display adapter 32. A keyboard 29, mouse 30, and speaker 31 all interconnected to bus 33 via user interface adapter 28, which may include, for example, a Super I/O chip integrating multiple device adapters into a single integrated circuit.

In exemplary embodiments, the processing system 300 includes a graphics processing unit 41. Graphics processing unit 41 is a specialized electronic circuit designed to manipulate and alter memory to accelerate the creation of images in a frame buffer intended for output to a display. In general, graphics processing unit 41 is very efficient at manipulating computer graphics and image processing and has a highly parallel structure that makes it more effective than general-purpose CPUs for algorithms where processing of large blocks of data is done in parallel.

Thus, as configured in FIG. 3, the system 300 includes processing capability in the form of processors 21, storage capability including system memory 34 and mass storage 24, input means such as keyboard 29 and mouse 30, and output capability including speaker 31 and display 35. In one embodiment, a portion of system memory 34 and mass storage 24 collectively store an operating system coordinate the functions of the various components shown in FIG. 3.

Turning now to an overview of technologies that are more specifically relevant to aspects of the invention, on a high bandwidth, high latency channel, utilizing TCP connections can cause large delays. This is because the first few TCP segments carry hardly any data since the window size is being negotiated while establishing the TCP connection. Large delays are caused by the slow-start algorithm implemented by the TCP protocol. Only after the optimal window sizes are determined by the protocol, which requires several packets to be exchanged, the true throughput of the channel is realized. On a high bandwidth, high latency network, this initial delay represents lost opportunity to transmit additional data. The term latency refers to any of several kinds of delays typically incurred in the processing of network data, such as the time it takes for a packet of data to go from a user's computer to a website server and back, for example. High latency networks generally suffer from long delays typically measured in milliseconds.

To establish a connection, transmission control protocol (TCP) uses a three-way handshake. Before a client attempts to connect with a server, the server must first bind to and listen at a port to open it up for connections: this is called a passive open. Once the passive open is established, a client may initiate an active open. To establish a connection, the three-way (or 3-step) handshake occurs stating with the active open is performed by the client sending a SYN to the server. The client sets the segment's sequence number to a random value A. In response, the server replies with a SYN-ACK. The acknowledgment number is set to one more than the received sequence number i.e. A+1, and the sequence number that the server chooses for the packet is another random number, B. Finally, the client sends an ACK back to the server. The sequence number is set to the received acknowledgment value i.e. A+1, and the acknowledgment number is set to one more than the received sequence number i.e. B+1. At this point, both the client and server have received an acknowledgment of the connection. The steps 1, 2 establish the connection parameter (sequence number) for one direction and it is acknowledged. The steps 2, 3 establish the connection parameter (sequence number) for the other direction and it is acknowledged. With these, a full-duplex communication is established.

With high bandwidth, high latency connections, transmission times can be upwards of 250 milliseconds to receive the first bit of data. Due to this latency, utilizing the above described TCP handshake can cause a delay for connections to high bandwidth, high latency connections, such as satellite connections. A TCP channel with a large throughput but a large latency could cause delays and a lost opportunity to transmit data during its initial connection setup phase due to the nature of the slow-star algorithm of TCP protocol.

In order to circumvent this lost opportunity to transmit data during the slow-start period of TCP, aspects of the invention introduce a secondary channel (that has a lower latency and lower throughput and costs much less). The secondary channel connects the same two end-points and is active only during the initial socket setup and is moved to the background once the setup is complete. All new connections start off by using the faster secondary channel. This secondary channel behaves as though it is the main channel for setting up the initial socket negotiation (i.e., TCP handshake). Since the latency (and the round-trip time) is lower on the secondary channel, the setup happens much faster than compared to a high bandwidth, high latency connection. The bulk data transfer between the TCP sockets can then move to the primary channel, having the added benefit of reducing the initial delays described above.

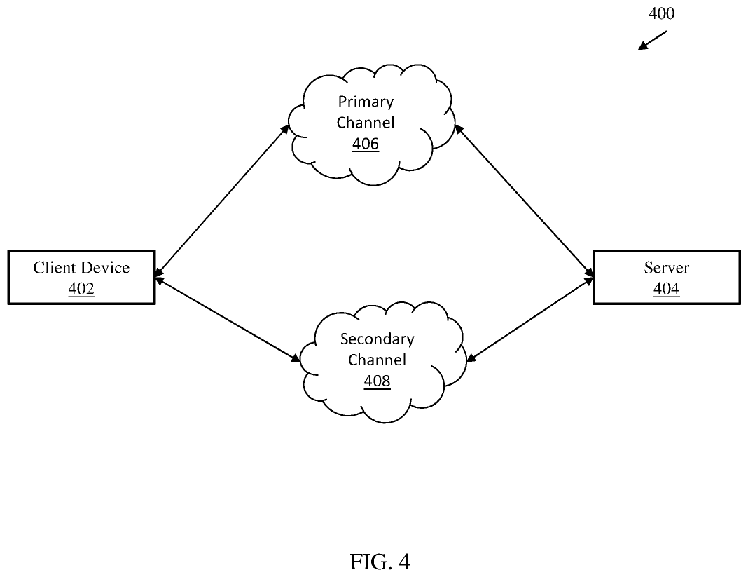

Turning now to a more detailed description of aspects of the present invention, FIG. 4 depicts a system for a two channel TCP connection according to embodiments of the invention. The system 400 includes two endpoints, a client device 402 and server 404. The client device 402 can be any type of computing device such as, for example, a desktop computer, a laptop computer, a smartphone, a tablet computer, a smart television, a smartwatch, and the like. The client device 402 includes a power source, processing resources, and a transceiver configured to communicate over a wired or wireless network connection. The server 404 can be any type of server device or computing device. In embodiments of the invention, the server 404 can include multiple server devices being accessed by the client device 402 over a network.

In one or more embodiments of the invention, the client device 402 and server 404 can be implemented on the processing system 300 found in FIG. 3. Additionally, the cloud computing system 50 can be in wired or wireless electronic communication with one or all of the elements of the system 400. Cloud 50 can supplement, support or replace some or all of the functionality of the elements of the system 400. Additionally, some or all of the functionality of the elements of system 400 can be implemented as a node 10 (shown in FIGS. 1 and 2) of cloud 50. Cloud computing node 10 is only one example of a suitable cloud computing node and is not intended to suggest any limitation as to the scope of use or functionality of embodiments of the invention described herein.

In embodiments of the invention, the client device 402 can access the server 404 through a primary channel 406 and a secondary channel 408. The primary channel 406 can be a high bandwidth, high latency network channel such as a satellite. The secondary channel 408 can be a low bandwidth, low latency network channel such as a WiMAX connection. The client device 402 connects to the server 404 through both the primary channel 406 and secondary channel 408. When a socket connection is first initiated by the client device 402 to the server 404, the TCP segments are routed through the faster (e.g., lower latency) secondary network 408. The first TCP segment to be transmitted would the SYN segment (as described in greater detail above). In response to the SYN segment, the server 404 responds with a SYN-ACK segment and a window size that would fit a connection on the primary channel 406.

In embodiments of the invention, through a large window size is seen by the client device 402, the client device 402 does not start sending a large amount of data. Instead, as part of the TCP slow start protocol, the client device 402 sends data and waits for an ACK packet from the server 404 to be received before the client device 402 can increase the number of in-flight data packets. The characteristics of the secondary channel 408 allow for the ACK packets (segments) from the server 404 to be received faster than if transmitted on the primary channel 406 due to the characteristics of the primary channel 406 being a high bandwidth with high latency. When the socket on the client device 402 determines that it is able to send a larger number of packets without waiting for the ACK packets first, the client device 402 can switch from the secondary channel 408 to the primary channel 406 which allow for the larger number of packets to traverse the primary channel 406 faster due to the high bandwidth of the primary channel 406. In one or more embodiments of the invention, the secondary channel 408 is closed when the client device 402 determines that the data stream on the primary channel 406 has surpassed that of the secondary channel 408. This determination can be content-dependent. In some contexts, the determination can be based on a byte count. However, in some embodiments, should the data be dynamically compressed (such as with video streaming services), the client device 402 can use a content-aware mechanism for determining when the primary channel 406 data stream has passed the position of the secondary channel 408.

Embodiments of the invention provide that two TCP connections are established simultaneously by the client device 402 to the server device 404. Once the data content on the primary channel 406 passes the data content on the secondary channel 408, the secondary channel 408 is closed using the normal TCP protocol sequence. In embodiments, there are two implementations of this: 1) only the client device 402 is aware of the mechanism, or 2) both the client 402 and server 404 devices are aware of the mechanism. However, if the server device 404 has authentication or other connection restrictions that prevent the client device 402 from making two simultaneous connections then the mechanism can be implemented on the server device 404 as well so that the server device 404 will realize that both connection requests are from a single client device 402 and not reject the secondary channel 408 connection request. In embodiments of the invention, the window size increases more quickly at first on the secondary channel 408 but eventually the windows size on the primary channel 406 will surpass it. Somewhere around that time the data content on the primary channel 406 will also surpass the content on the secondary channel 408, indicating that the secondary channel 408 may be closed.

For example, consider a video streaming service. The user (client device 402) would request that a video be played through their device/software interface (e.g., a web browser or dedicated video application). The client device 402 would open TCP connections over both the high bandwidth, high latency (primary 406) channel and the low bandwidth, low latency (secondary 408) channel to the video service provider, cloud server, or the like. The server device 404 would begin streaming data over both connections. Because the video data arrives sooner on the secondary channel 408 at first, the client device 402 begins video playback immediately, albeit at a lower resolution because the server device 404 would likely perform additional compression on the video stream due to the lower bandwidth of the secondary channel 408. Once the client device 402 detects that the video stream on the primary channel 406 has caught up with the video stream on the secondary channel 408, the client device 402 would start displaying video from the stream on the primary channel 406 and then close the secondary channel 408. The server device 404 would receive the standard TCP FIN/FIN+ACK packet sequence from the client 402 and close the server 404 end of the secondary channel 408 connection. Video playback would continue on the primary channel 406.

In embodiments of the invention, the secondary channel 408 connects two end-points (client device 402 and server 404) and is active during initial socket setup. After the initial socket setup is completed, the secondary channel 408 is moved to the background or disconnected. In this sense, the secondary channel 408 having the lower latency acts as though it is the primary channel 406 for setting up initial socket negotiation and decreasing setup time. The system 400 then moves bulk data transfer between the TCP sockets to the primary channel 406 after setup.

In embodiments of the invention, when the client device 402 establishes the TCP connection to the server 404 over the secondary channel 408, the client device 402 can establish a data stream between the client device 402 and the server 404. The data stream can be any type uploading or downloading of data to or from the server 404. After the TCP connection to the server 404 is established over the primary channel 406, a new data stream can be established between the client device 402 and the server 404 accessing the same data. The data stream over the secondary channel 408 is slower than the data stream over the primary channel 406 due to the lower bandwidth of the secondary channel 408 as compared to the higher bandwidth of the primary channel 406. The data stream on the primary channel 406 eventually catches up to the data stream over the secondary channel 408 despite the slow start up socket connection. The system 400 can monitor each of the data streams to determine a caught up point at which time, the system will switch to the primary network 406 and either disconnect the secondary network 408 or move the secondary network 408 to the background of the session. To determine when the data stream over the primary channel 406 is caught up to the data stream over the secondary channel 408, the system 400 can analyze the packet numbers in the data stream that serve as indications (or indicia) of where the data stream is in transmission. In other embodiments of the invention, the system 400 can switch to the primary channel 406 data stream based on the passage of a certain amount of time that can be pre-defined or calculated based on the bandwidth for each connection. The time can be calculated by analyzing the bandwidth for each connection and the starting time for each data stream to calculate when the data stream over the primary channel would catch up based on the passage of a certain amount of time.

In one or more embodiments, the bandwidth of the primary channel 406 can be an order of magnitude larger than the bandwidth of the secondary channel 408. In addition, the latency of the primary channel 406 can be an order of magnitude larger than the latency of the secondary channel 408. Being an order of magnitude higher for latency, the initial TCP connection to the primary channel 406 can be on the order of seconds as compared to the TCP connection to the secondary channel 408.

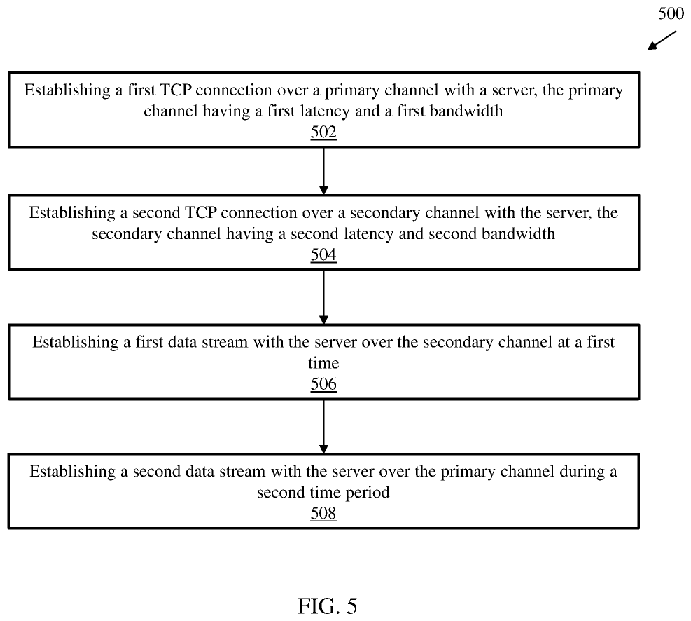

FIG. 5 depicts a flow diagram of a method for decreasing TCP connection time for high latency channels according to one or more embodiments of the invention. The method 500 includes establishing a first TCP connection over a primary channel with a server, the primary channel having a first latency and a first bandwidth, as shown in block 502. At block 504, the method 500 includes establishing a second TCP connection over a secondary channel with the server, the secondary channel having a second latency and second bandwidth. Then, the method 500, at block 506, includes establishing a first data stream with the server over the secondary channel at a first time period. And at block 508, the method 500 includes establishing a second data stream with the server over the primary channel during a second time period, wherein a start of the second time period is after the first time period.

Additional processes may also be included. It should be understood that the processes depicted in FIG. 5 represent illustrations, and that other processes may be added or existing processes may be removed, modified, or rearranged without departing from the scope and spirit of the present invention.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method for decreasing TCP connection time for high latency channels, the method comprising:
establishing a first TCP connection over a primary channel with a server, the primary channel having a first latency and a first bandwidth;
establishing a second TCP connection over a secondary channel with the server, the secondary channel having a second latency and second bandwidth;
establishing a first data stream with the server over the secondary channel at a first time period; and
establishing a second data stream with the server over the primary channel during a second time period;
wherein a start of the second time period is in parallel with the first time period.

2. The computer-implemented method of claim 1, wherein the first latency is an order of magnitude higher than the second latency; and
wherein the first bandwidth is an order of magnitude higher than the second bandwidth.

3. The computer-implemented method of claim 1 further comprising:
monitoring the first data stream with the server over the secondary channel;
monitoring the second data stream with the server over primary channel; and
determining that a first indicia of the first data stream matches with a second indicia of the second data stream.

4. The computer-implemented method of claim 3, wherein the first indicia comprises a first byte number in the first data stream; and
wherein the second indicia comprises a second byte number in the second data stream.

5. The computer-implemented method of claim 3, further comprising:
disconnecting the first data stream with the server over the secondary channel based at least in part on the determination that the first indicia of the first data stream matches with the second indicia of the second data stream.

6. The computer-implemented method of claim 1 further comprising:
monitoring the first data stream with the server over the secondary channel;
monitoring the second data stream with the server over primary channel; and
disconnecting the first data stream with the server over the secondary channel based at least in part a completion of a third time period.

7. The computer-implemented method of claim 6, wherein the third time period is determined based at least on the first bandwidth and the second data bandwidth.

8. A system for decreasing TCP connection time for high latency channels, the system comprising:
a processor communicative coupled to a memory, the processor configured to:
establish a first TCP connection over a primary channel with a server, the primary channel having a first latency and a first bandwidth;
establish a second TCP connection over a secondary channel with the server, the secondary channel having a second latency and second bandwidth;
establish a first data stream with the server over the secondary channel at a first time period; and
establish a second data stream with the server over the primary channel during a second time period;
wherein a start of the second time period is in parallel with the first time period.

9. The system of claim 8, wherein the first latency is an order of magnitude higher than the second latency; and
wherein the first bandwidth is an order of magnitude higher than the second bandwidth.

10. The system of claim 8, wherein the processor is further configured to:
monitor the first data stream with the server over the secondary channel;
monitor the second data stream with the server over primary channel; and
determine that a first indicia of the first data stream matches with a second indicia of the second data stream.

11. The system of claim 10, wherein the first indicia comprises a first byte number in the first data stream; and
wherein the second indicia comprises a second byte number in the second data stream.

12. The system of claim 10, wherein the processor is further configured to:
disconnect the first data stream with the server over the secondary channel based at least in part on the determination that the first indicia of the first data stream matches with the second indicia of the second data stream.

13. The system of claim 8, wherein the processor is further configured to:
monitor the first data stream with the server over the secondary channel;
monitor the second data stream with the server over primary channel; and
disconnect the first data stream with the server over the secondary channel based at least in part a completion of a third time period.

14. A computer program product for decreasing TCP connection time for high latency channels, the computer program product comprising a computer readable storage medium having program instructions embodied therewith, wherein the computer readable storage medium is not a transitory signal per se, the program instructions executable by a processor to cause the processor to perform a method comprising:
establishing a first TCP connection over a primary channel with a server, the primary channel having a first latency and a first bandwidth;
establishing a second TCP connection over a secondary channel with the server, the secondary channel having a second latency and second bandwidth;
establishing a first data stream with the server over the secondary channel at a first time; and
establishing a second data stream with the server over the primary channel during a second time period;
wherein a start of the second time period is in parallel with the first time period.

15. The computer program product of claim 14, wherein the first latency is an order of magnitude higher than the second latency; and
wherein the first bandwidth is an order of magnitude higher than the second bandwidth.

16. The computer program product of claim 14 further comprising:
monitoring the first data stream with the server over the secondary channel;
monitoring the second data stream with the server over primary channel; and
determining that a first indicia of the first data stream matches with a second indicia of the second data stream.

17. The computer program product of claim 16, wherein the first indicia comprises a first byte number in the first data stream; and
wherein the second indicia comprises a second byte number in the second data stream.

18. The computer program product of claim 16, further comprising:
disconnecting the first data stream with the server over the secondary channel based at least in part on the determination that the first indicia of the first data stream matches with the second indicia of the second data stream.

19. The computer program product of claim 14 further comprising:
monitoring the first data stream with the server over the secondary channel;
monitoring the second data stream with the server over primary channel; and
disconnecting the first data stream with the server over the secondary channel based at least in part a completion of a pre-defined time period.

20. The computer program product of claim 19, wherein the third time period is determined based at least on the first bandwidth and the second data bandwidth.
